(19) United States
(12) Patent Application Publication
(10) Pub. No.: US 2007/0174107 A1
(43) Pub. Date: Jul. 26, 2007

(54) Method and system for product design

(76) Inventor: Gosakan Aravamudan, Bangalore (IN)

Correspondence Address: Ashok Tankha,;Lipton, Weinberger & Husick, 36 Greenleigh Drive, Sewell, NJ, 08080, US

(21) Appl. No.: 11/517,967

(22) Filed: Sep. 8, 2006

(30) Foreign Application Priority Data
Sep. 12, 2005 (IN) 1272/CHE/2005

(51) Int. Cl. G06Q 99/00; G07G 1/00; G07F 7/00

(52) U.S. Cl. 705/10; 705/27; 705/1

(57) ABSTRACT

The present invention illustrates a method and system of textual analysis for designing a new product for a required end application using textual analysis of information sources. A method and system of textual analysis is presented for designing a new product for an entirely new end application using one or more existing components. The method of designing a new product for a required end application comprises the steps of listing the existing components, identifying and extracting new components, creating new sets of components, generating specification parameters and ranking the new sets of components based on synergy and specification parameters. The method of designing a new product for an entirely new end application, comprises the steps of listing the existing components, searching the claims of patent documents and identifying preambles that represent new applications, replacing the means of achieving known functions under these preambles and ranking the new sets of components.

### BACKGROUND OF THE INVENTION

This invention relates in general to a knowledge management system and relates specifically to a product design tool.

Identification of suitable components and systems to meet design criteria and satisfaction of unmet application needs in the product design process is a resource constraint and time consuming activity for the product design team. Also, modification of components or systems of a product in a certain industry allow the use of that application or product in another related or non-related industry to satisfy an entirely different application or need. Hence, designers, product managers and marketers continuously search for new components or systems for their application requirements, and also for multiple applications for their products.

In the conventional product design process, typically a scientist with domain expertise in a particular technology area designs a product to address the unmet application need. However, the best component that meets the application may not necessarily reside in or evolve from the technology sector that the scientist has experience in. This invention, in part, addresses and identifies components from the entire technology spectrum to meet the need of the optimum component or system for the new product.

For example, consider a semiconductor manufacturer ABC Company who manufactures an Indium Gallium Arsenide (InGaAs) semiconductor chip used for light detection, and sells receivers containing the InGaAs chips to fiber-optic customers in the telecommunications industry. Assume that the demand for fiber-optic telecommunication equipment has declined and ABC Company is unable to find customers for its packaged InGaAs chips in the telecommunications industry. The marketers and designers of ABC Company have a strong understanding of the application of the InGaAs chip in the telecommunications industry, but are unaware of the possible applications of the InGaAs chip in other industries, for example, the defense, automotive or medical industries. In the defense industry, InGaAs chips are used as sensors in the tail wings of fighter aircrafts. In the automotive industry, InGaAs chips are used in the communication system of high end and lightweight car models. In the medical industry, InGaAs chips are used in optical sensing of high throughput screening applications. There are many additional applications for the InGaAs material in other industries, for example use of InGaAs chips in historic material conservation, ice detection in aircraft wings, camouflage detection in warfare and semiconductor wafer inspection. It is unrealistic to expect a marketer or a designer at ABC Company to have knowledge of applications of a particular component or system for all industries. In the ideal case, when a designer needs to identify and design a component for a particular application, the designer itemizes all the component options that the designer is aware of that meet the application requirements, and thereafter selects the most appropriate component.

Consider the downstream end of a design process, for example where a medical device firm DEF Company in the area of high throughput screening is looking for a component to determine loss in the intensity of light after the passage of the light through a liquid medium. The firm is looking for the ideal component for such a light detection application. The designers of DEF Company are probably aware of one or two components that meet the light detection application such as the use of an Indium Gallium semiconductor chip. However, the ideal solution could be any of the following components: InGaAs chips, Indium Gallium (InGa) chips, or Indium Phosphide (InP) semiconductor chips.

There are solutions available in the market today that generate synonyms and identifying word relationships. A visual map of related words assists the designer in thinking out of the box. Results are presented in an interactive visual map. Random words are generated to stimulate the thinking process. Words and phrases and colloquialisms are combined to stimulate non-linear thought. In some cases, a set of leading questions are asked and the response to the question advances the process a step further in the selection of a component, development of the product, or creation of new idea. Current solutions provide a synonym list tailored to specific technical fields, such as the aerospace, automotive, biotechnology, manufacturing, and pharmaceutical industries.

The conventional solutions today provide support for lateral thinking, or out of the box thinking through synonym generation, but are not comprehensive and rarely provide focused results. There is an unsatisfied need for a tool that provides comprehensive and accurate component or system alternatives to address a given application, or for cross-industry marketing of a component, product or application. There is also an unsatisfied need for a tool that provides comprehensive and accurate application alternatives for a given component. There is also an unsatisfied need for a tool that provides ability to rank multiple solutions based on synergy among elements, relevance and novelty.

### SUMMARY OF THE INVENTION

The present invention illustrates a method and system of textual analysis for designing a new product for a required end application using textual analysis of information sources. A method and system of textual analysis is presented for designing a new product for an entirely new end application using one or more existing components. The method of designing a new product for a required end application comprises the steps of listing the existing components, identifying and extracting new components, creating new sets of components, generating specification parameters and ranking the new sets of components based on synergy and specification parameters. The method of designing a new product for an entirely new end application, comprises the steps of listing the existing components, searching the claims of patent documents and identifying preambles that represent new applications, replacing the means of achieving known functions under these preambles and ranking the new sets of components.

One advantage of the invention is that the user is able to choose from an exhaustive ranked set of available product combinations or function combinations to design innovative products.

Another advantage of the invention is that it provides the user an exhaustive set of solutions for new product development across multiple industries and applications.

Another advantage of the invention is that it extracts solutions from information sources that are constantly updated, hence the number of potential solutions to a problem grows over time as new technologies and applications are introduced in the market.

Another advantage of the invention is that it identifies new components or systems that solve a given function.

Another advantage of the invention is that it identifies new functions for a given component or system of components.

Another advantage of the invention is that it identifies new processes of achieving a given function.

Another advantage of the invention is that it identifies new functions for given existing processes.

Another advantage of the invention is that the user is provided a ranked sets of new components or systems that solve a given function. For example, in one case, the user may be given a ranked set of two thousand possible component combinations for a car lock system.

Another advantage of this invention is that it enables the user to rank the results on one or more of the following: novelty, industry focus and synergy among components or functions.

A more complete understanding of the present invention, as well as further features and advantages of the present invention will be obtained by reference to the following detailed description and drawings.

The applicant for grant of this patent, in a previously submitted U.S. patent application titled “Component and Application Finder”, application Ser. No. 10/957,906 filed on 04 Oct. 2004, describes some of the elements and methods used in this application. References to this earlier filed patent application are specifically made where the components are described in this application.

### BRIEF DESCRIPTION OF DRAWINGS

FIG. 1 illustrates a method of textual analysis used for designing a new product for a predefined end application.

FIG. 2 illustrates the architecture of a new product generation engine.

FIG. 3A illustrates the functional environment as a hierarchical tree-structured link of products, components, and subcomponents linked by their functions.

FIG. 3B illustrates the preliminary break-up of the automotive locking and alarm system.

FIG. 3C illustrates the input screen on the product component application tree that the product designer has filled in manually.

FIG. 4A and FIG. 4B illustrates the component application logic that is applied on the textual information sources to extract new components for the known functions.

FIG. 4C illustrates by way of example, the application of the component application logic to the information on a website on the internet.

FIG. 5A illustrates the industry vertical synergy by way of example.

FIG. 5B illustrates the textual proximity synergy by way of example.

FIG. 6A displays the results of all the components extracted for the known functions of the automotive lock and alarm system example.

FIG. 6B illustrates the outputs of the new product generation engine for the automotive locking and alarm system example.

FIG. 7A illustrates the method of identifying a new application and designing a new product to address the new application.

FIG. 7B illustrates the architecture of function innovation engine.

FIG. 8A and FIG. 8B displays the final output of the function innovation engine.

### DETAILED DESCRIPTION OF DRAWINGS

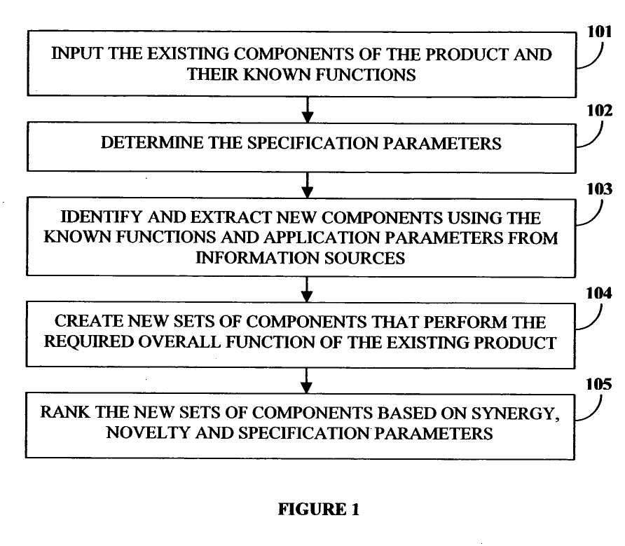

FIG. 1 illustrates a method of textual analysis used for designing a new product for a predefined end application. The existing and known components of the product and their respective known functions are inputted as text 101. The known variables, i.e., the existing product, the existing product's internal components and the known functions of the components are inputted into the relevant fields in the input user interface of a computer display on a personal computer. Users of this invention typically include product designers, product line managers, chief technology officers or other users involved in the design of products and solutions.

After the existing product, existing component and their known functions are inputted, one or more information sources are searched for new components that perform the same functions of the existing components of the existing product. The information sources include one or more of the following: the world wide web, commercial information sources, patents, technical literature, product specification sheet and other sources.

The identified and extracted new components are used to create new sets of components 103, 104. Each new set of components performs the required overall function of the existing product. Specification parameters of the existing components are generated and the permissible range of values of each specification parameter is specified.

The new sets of components are ranked. The ranking process comprises the steps of ranking new sets of components based on synergy between components, and ranking by specification parameters. Higher ranks are awarded to those new sets of components that contain components whose parameter values lie within said permissible range of values 105. Higher ranks are awarded to those new sets of components that contain at least one component that is an existing component within the existing product.

The method of extraction of new components that perform the functions of the existing components comprises the steps of conducting a search and thereafter extracting the new components from the claims section of patent documents. The method of extraction includes the step of segmenting a claim into component sections by executing a component extraction logic function in the claims. Next the component sections are segmented into components and their functions, by executing a component application extraction logic. Only those components whose functions are similar to the functions of respective existing components are extracted.

Product specification documents or data sheets contain data and text arranged in tables that can be extracted relatively easily when compared to extracting specification information from non-tabulated information sources. The specification parameters of the existing components are generated 102. The permissible range of values of each specification parameter is then specified. Product specification documents of the existing products are identified in the given information sources by identifying product specification document markers in the information sources. The product specification markers are certain text unique to product specification documents and the structural arrangement of the unique text in the product specification document. Examples of product specification markers include: “data sheet”, “product specification sheet”, “product features”, “tables”, “specification”, “date”, “ordering information”, “parameters”, “units” etc . . . Note that most of the product specification sheets are provided in the Acrobat .pdf format of Adobe Inc.

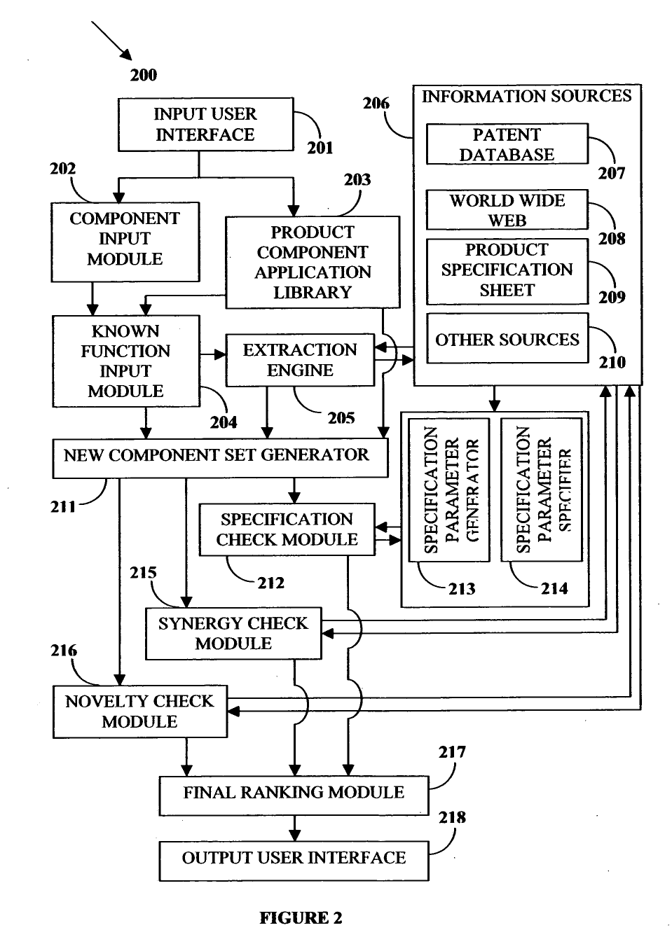

FIG. 2 illustrates the architecture of a new product generation engine 200 that implements the method of designing a new product for a pre-defined overall function. The existing product, the existing product's components and their respective known functions are fed into the component input module 202 through an input user interface 201.

After the existing product, existing component and their known functions are inputted through the known function input module 204, the extraction engine 205 searches one or more information sources 206 to identify and extract new components that perform the same functions of the existing components. Examples of information sources 206 include patent database 207, World Wide Web 208, product specification sheet 209, and other sources 210.

The break up of products into components and the break up of components into subcomponents and so on can be performed manually or by using a product component application library 203. The method of creating the product component application library 203 using information contained in the claims of a patent is described in a U.S. patent application Ser. No. 10/957,906, titled “Component and Application Finder” filed on 04 Oct. 2004. The product component application library 203 can be used to create new component sets automatically. Sets of new components are created by the new component set generator 211. Each one of these new sets of components performs the required overall function of the existing product.

The synergy check module 215 ranks new sets of components based on the synergy between new components within a set of components. Synergy refers to the phenomenon of two or more components acting within a product to create an effect that is greater than the sum of the effects each individual component.

There are three types of synergy ranks determined by the synergy check module 215, including ranking by industry vertical synergy, textual proximity synergy and sub-component overlap synergy.

Industry vertical synergy represents the synergy between two or more components as a result of their usage in a common industry vertical. Examples of industry verticals include automotive, telecommunications, security, home construction, etc . . . In the case of industry vertical synergy, a higher rank is awarded to a new set of components if more than one of the components of the new set of components have applications in a common industry vertical.

Textual proximity synergy represents the synergy between two or more components as a result of their usage within a text source, for example in a web page. In the case of textual proximity synergy, a higher rank is awarded to a new set of components if more than one of the components of the new set of components lie in close textual proximity within a specific information source.

Subcomponent overlap synergy represents the synergy between two or more components as a result of the commonality of one of their subcomponents. For example an InGaAs Receiver and an InGaAs transmitter have a component overlap synergy because both use a hermetic package. In the case of subcomponent overlap synergy, a higher rank is awarded to a new set of components if two or more the components of the new set of components have a common subcomponent.

Optionally, a novelty check module 216 is used to rank the new component sets based on the novelty of combination of the new components. First a determination is made if some or all of these components reside in any single claim of a patent document. Then a higher rank is awarded to those new sets of components that contain the least number of components that occur within a claim of a patent or prior art document.

The specification check module 212 provides the highest ranking to those new sets of components whose specification parameters fall within a predefined permissible range.

The specification parameter generator 213 generates the specification parameters of the existing components. The specification parameter specifier 214 specifies the permissible range of values of each specification parameter. This specification of permissible range is either implemented through human intervention or is automatically generated. Product specification documents of the existing products from the given information sources 206 are identified by the process of identifying product specification document markers in the information sources 206. The product specification markers are certain unique text and the spatial arrangement of the unique text in the product specification document. The new sets of components whose specification parameters fall within the target permissible range are awarded the highest ranks.

The final ranking module 217 allocates a predetermined weight to each type rank, i.e., to the ranks determined by the specification check module 212, synergy check module 215 and novelty check module 216.

The final set of ranked new set of components is presented to the product designer on an output user interface 218 of a computer display.

The following example is used to explain the working of the system and processes of this invention. Assume that Company ‘A’ currently manufactures a car lock system consisting of the following two major components: an automobile mounted set of components and a hand-held unit. The automobile mounted set of components includes a door lock sensor, door locking module and an infrared transmitter. The handheld unit contains an infrared receiver, infrared transmitter and display. Consider the case where a product designer of Company ‘A’ desires to design a novel car lock system that is an improvement over the currently available car lock product of Company ‘A’.

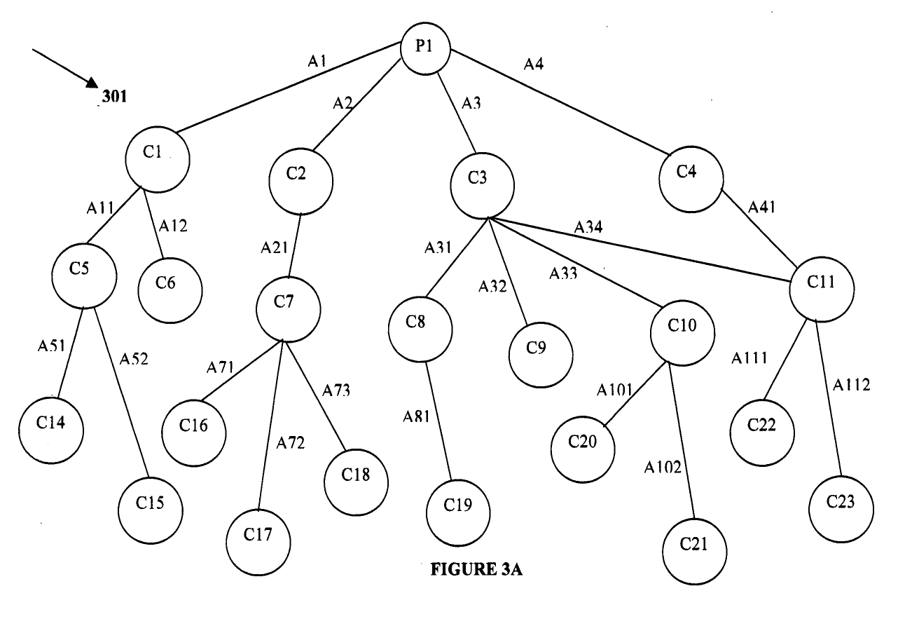

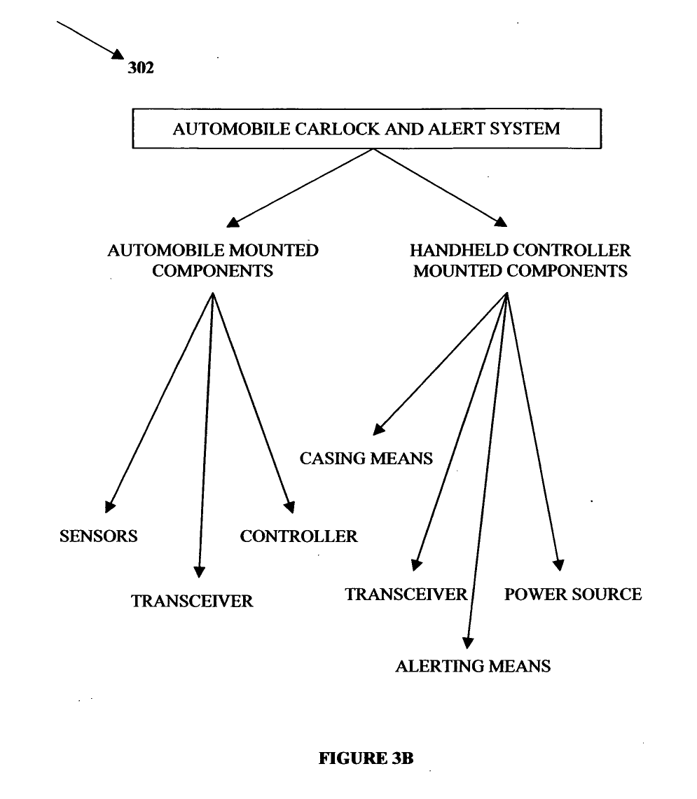

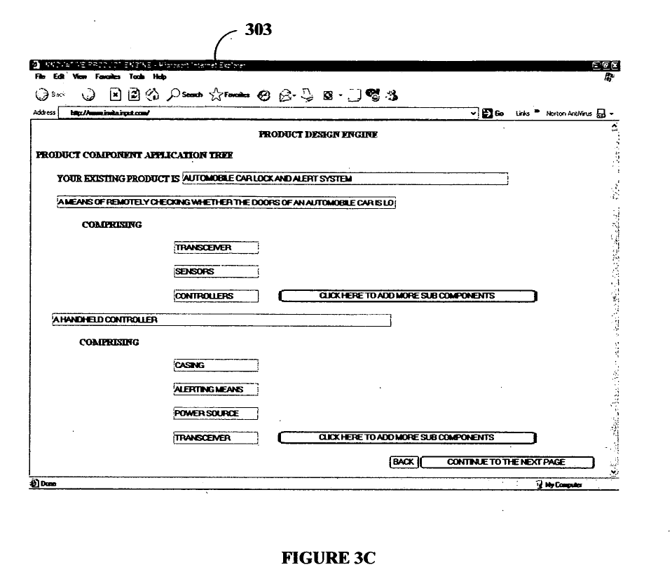

FIG. 3A illustrates the functional environment as a hierarchical tree structured link of products, components, and subcomponents linked by their functions 301. Assume that product P1 is comprised of components C1, C2, C3 and C4. Each of the components C1, C2, C3 and C4 serves an application A1, A2, A3 and A4 respectively. Further the component C1 comprises the sub-components C5, C6 serving application A11 and A12, C2 comprises the sub-component C7 serving application A21, C3 comprises the sub-component C8, C9, C10 and C11 serving application A31, A32, A33, A34 respectively and C4 comprises the sub-components C11 serving application A41. These sub components further comprise components like C5 comprising sub-components C14 and C15 serving application A51 and A52, C7 comprising sub-components C16, C17, C18 serving application A71, A72 and A73, C8 comprising subcomponents C19 serving application A81, C10 comprising sub-components C20 and C21 serving application A101 and A102, and C11 comprising sub-components C22 and C23 serving application A111 and A112

The product application library 203 comprises a predetermined and stored set of products linked to their components through the component's applications.

FIG. 3B illustrates the preliminary break-up of the automotive locking and alarm system into two sections, namely, automobile mounted components, and the hand-held components 302. Further, each of the two sections is broken-down into key-components. The automobile mounted components are further broken down into sensors, transceiver, and the lock-controller. Similarly, the handheld components are broken down to a power source, a transceiver, an alerting means, and a casing and carrying means.

The above breakdown of products into components and the break of components into sub-components and so on can be performed manually or automatically by using the inputs from the product component application library 203. The method of creating the product component application library 203 using information contained in the claims of a patent is described in a U.S. patent application Ser. No. 10/957,906, titled “Component and Application Finder” filed on 04 Oct. 2004.

FIG. 3C illustrates the input screen on the product component application tree that the product designer has filled in manually 303. The extraction engine 205 conducts a text based search of the information sources 206 using the above available information on the parameters and ranks the textual information sources 206 based on the existence of these parameters in the text of the textual information sources 206. The extraction engine 205 then processes the highest ranked textual information sources 206. The extraction engine 205 applies product component application logic on the highest ranked textual information sources 206 to conduct the extraction of new components that perform the known functions.

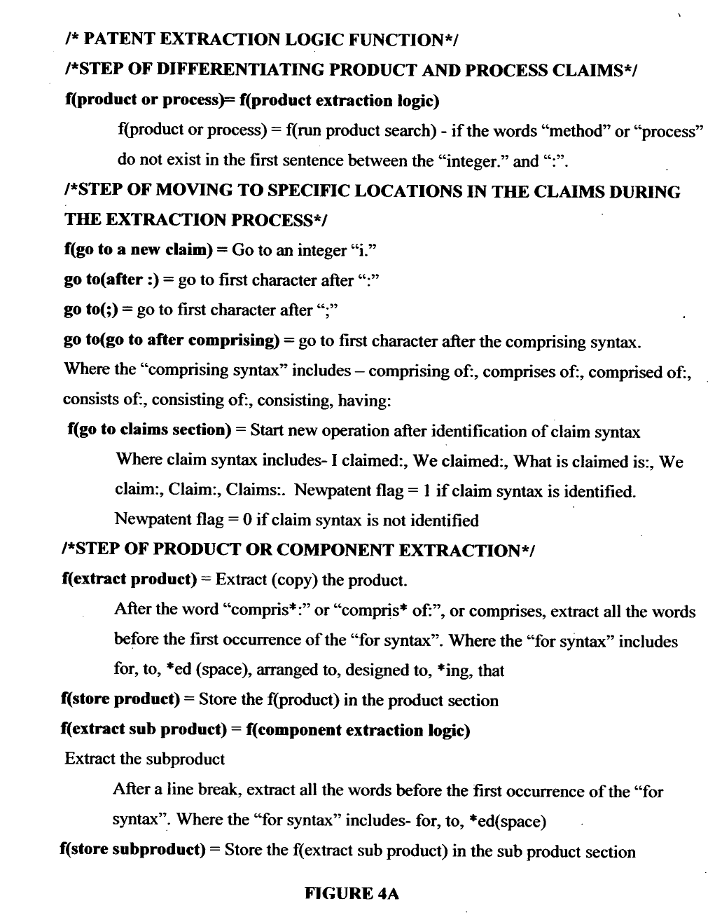

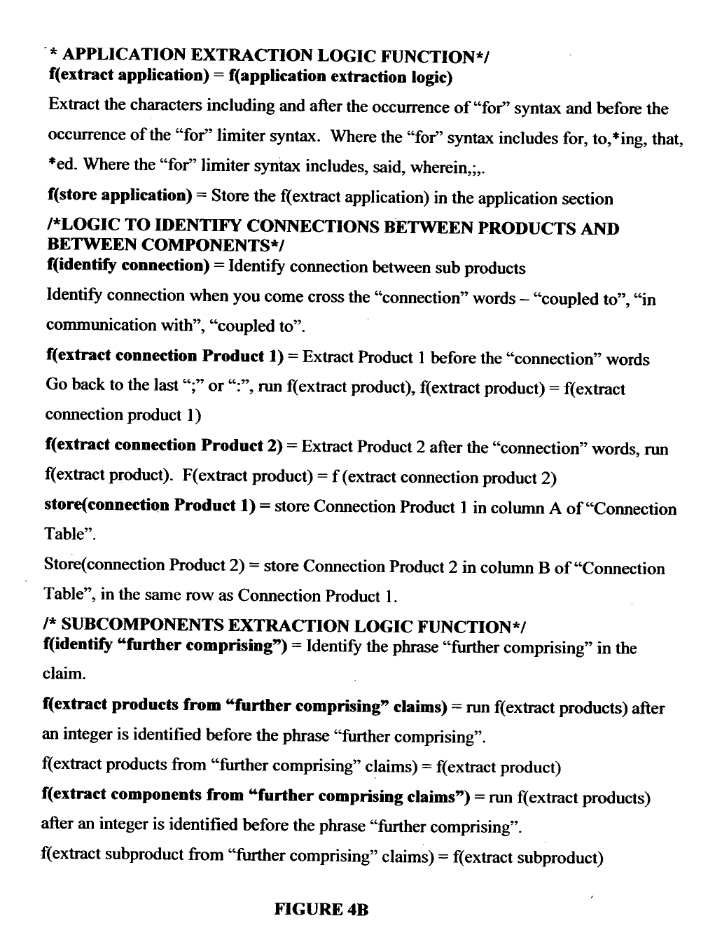

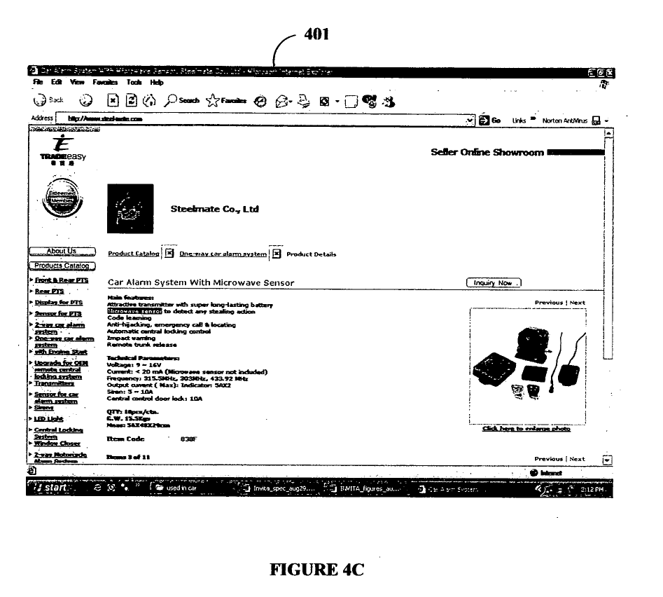

FIG. 4A and FIG. 4B illustrates the component application extraction logic that is applied to the textual information sources 206 to extract new components for the known functions.

The component application extraction logic functions described in FIG. 4A and FIG. 4B consist of multiple steps. The logic for each step is illustrated under the headings /*LOGIC FOR . . . */ in FIG. 4A and FIG. 4B. In the first step, the logic moves the parser to a specific section of the patent document, for example, to a certain section in the patent claims. In the second step, the product claims and the process claims must be differentiated. In the third step, the components are identified and extracted.

The following example explains the logic illustrated in FIG. 4A and FIG. 4B.

Consider a patent with the following claim:

What is claimed is:

1. A spread spectrum codeless receiver for reception of direct sequence spread spectrum signals without knowledge of the spreading code therein, comprising:
a quadrature mixer for accepting an input direct sequence spread spectrum signal and a local oscillator signal, for conversion of the baseband signals of the input signal to first and second quadrature signals;
a divider circuit coupled to the oscillator circuit for providing a reference signal divided-down in frequency from the frequency of the local oscillator signal;
a summing circuit coupled to the divider circuit and the multiplier circuit, for combining the Doppler offset signal and the reference signal;
a microchip integrated circuit board comprising of a microprocessor.
   Need to add a sentence here as what you are doing. Start a new parsing operation. Identify the claim syntax. The claim syntax includes “I claim:”, “We claim:”, “What is claimed is:”, “We claim”, “Claim” and “Claims”. Parse the words after claim syntax. Differentiate between the product and process claim by identifying the presence of the word “method” to classify the claim as a method or process claim and the non-occurrence of the word “method” to classify the claim as a product claim in the first sentence. The first sentence is defined as the characters between an integer and “:”. In the above example, there is no “method” word occurring in the first sentence between the integer and “:”. Hence, the example represents a product claim.
   Go to an integer “i”. Extract all words before the comprising syntax. The “comprising syntax” comprises—“comprising of”, “comprises of”, “comprised of”, “consists of”, “consisting of”, “consisting”, “having”, “including”, “includes”:
   In the above example, the extracted section is: “A spread spectrum codeless receiver for reception of direct sequence spread spectrum signals without knowledge of the spreading code therein,”
   If the “for” syntax that includes “for”, “to”, words ending with “ed”, “arranged to”, “designed to, and words ending with “ing”, is present in the sentence before the “comprising syntax”, extract all the words before the first occurrence of the “for syntax” and after the first occurrence of the “for syntax”. Store the word before the “for syntax” as a product and after the “for” syntax and before the “comprising syntax” as the application of the product. If the “for” syntax is not present, store all words before the comprising syntax as a product.
   In the example above:
   The product is “A spread spectrum codeless receiver:”
   The product's application is “reception of direct sequence spread spectrum signals without knowledge of the spreading code therein,”
   Next, the components and their applications are extracted. After a line break, count the lines in which line ends with semicolon or comma. Parse all words before a semicolon or a comma.
   In the example above, the following characters are parsed and extracted:
a quadrature mixer for accepting an input direct sequence spread spectrum signal and a local oscillator signal, for conversion of the baseband signals of the input signal to first and second quadrature signals
a divider circuit coupled to the oscillator circuit for providing a reference signal divided-down in frequency from the frequency of the local oscillator signal
a summing circuit coupled to the divider circuit and the multiplier circuit, for combining the Doppler offset signal and the reference signal
a microchip integrated circuit board comprising a microprocessor.
   If “for” syntax is present in the sentence before a comma or a semicolon, extract all the words before “for” syntax and store it as sub product. If the “for” syntax is not present in the sentence, store all words before a semicolon, or a comma, as a sub-product. Ignore lines that start with “means”. The “means for . . . ” product claims do not identify a product and provide only the application or functionality of the product. Hence, “means for . . . ” product claims are not suitable for extraction.
   If “for” syntax is present in the lines before a semicolon or a comma, extract words after the occurrence of “for” syntax and before the occurrence of “for” limiter syntax. The “for” limiter syntax words such as “includes”, “said” and wherein. Store it as subproduct_application.
   The extraction procedure, applied to the example, yields the following result:
   Component 1 is “a quadrature mixer”.
   Component 2 is “a divider circuit coupled to the oscillator circuit”.
   Component 3 is “a summing circuit coupled to the divider circuit and the multiplier circuit”.
   Component 4 is “a microchip integrated circuit board comprising of a microprocessor”.
   Application 1 is “accepting an input direct sequence spread spectrum signal and a local oscillator signal, for conversion of the baseband signals of the input signal to first and second quadrature signals”;
   Application 2 is “providing a reference signal divided-down in frequency from the frequency of the local oscillator signal”;
   Application 3 is “combining the Doppler offset signal and the reference signal”.
   Application 4 is “”. This indicates no application.
   Next, identify the connection between sub-products. Then locate the occurrence of the “connection words”, such as “coupled to”, “in communication with”. Extract the characters before the “connection” words which, in the example above, is “coupled to” and store the characters as Connection Product 1 in column A of the “Connection Table”.
   In the example above:
   Connection Product 1 is the Divider Circuit.
   Extract the word before the “connection” words, which is “coupled to” and store it as a Connection Product 2 in column B of “Connection Table” in the same row as Connection Product 1.
   In the example above:
   Connection Product 2 is the “summing circuit”.
   Then, identify the phrase “further comprising” in the claim. If “comprising syntax” is present in any sub-product, extract all the words before “comprising” and store them as a sub-component. When data is stored, the sub-component is treated as a component. The component that contains the sub component is treated as a product. In the example above, the subcomponent is “a microprocessor”.

FIG. 4C illustrates, by way of example, the application of the component application logic to the information on a website on the internet 401. The highlighted portions of the text in the website are extracted by the component application logic. The search for the word “sensor” or its synonyms in information sources results in the identification of the sentence “Microwave sensor for detecting stealing action” in the web page displayed in FIG. 4C. This sentence is highlighted in FIG. 4C. The component application logic applies the following rule: If “for” syntax is present in the sentence after the word “sensor” or its synonym, extract the words before “for” syntax and store it as component and extract the words after the word “for” and store it as an application of the component. Hence, the component application extraction function extracts “microwave sensor” as a component performing the function of “detecting stealing action”.

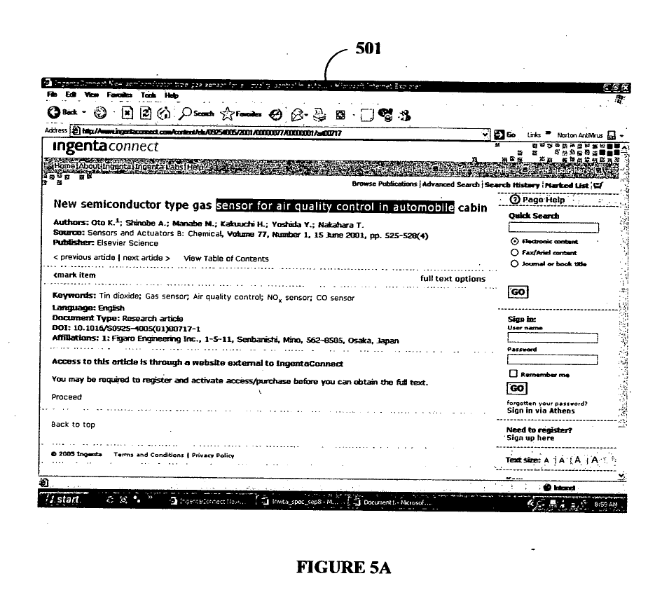

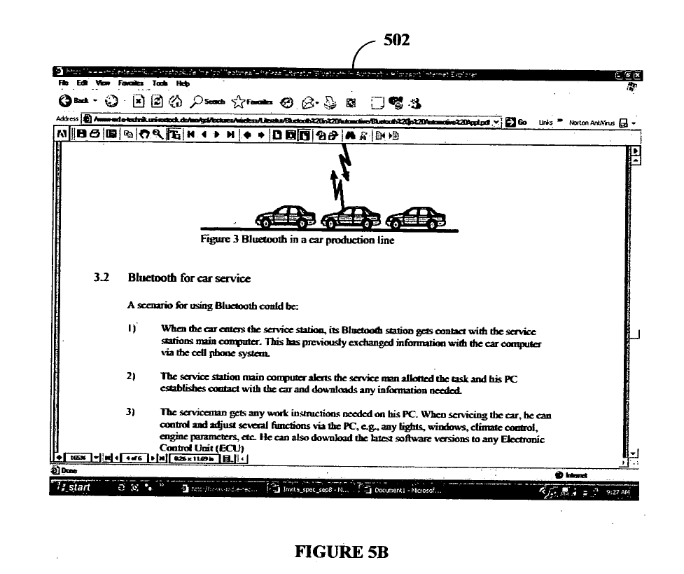

FIG. 5A illustrates, by way of example, an industry vertical synergy 501. A higher rank is awarded to a new set of components if more than one of the components of the new set of components has applications in a common industry vertical. Consider an example, wherein the synergy check module 215, applies the industry vertical synergy search to the URL http://www.ingentaconnect.com/content/els/09254005/2001/00000077/00000001/art0071 7. The component extracted from this URL gets a higher ranking because it has an application in the automobile industry. Note that the product designer wishes to design an automobile car lock system for the automobile industry.

FIG. 5B illustrates, by way of example, textual proximity synergy 502. Textual proximity synergy comes into consideration when two or more components generated by the sub-component combination generator are closely related for a specific application. This means that a higher rank is awarded to a new set of components if more than one of the components of the new set of components lie in close textual proximity within a specific information source. This example has been chosen from the URL http://www-md.e-technik.uni-rostock.de/ma/gol/lectures/wireless/Literatur/Bluetooth%/20in%20Automotive/Bluetooth %20in%20Automotive%20Appl.pdf. Any new component set containing a bluetooth transmitter or bluetooth receiver gets a higher ranking because the words “bluetooth” and “car” lie in close textual proximity. The synergy check module 215 ranks new sets of components based on the count of common characteristics between components. First, the usage characteristics of the components are determined. Then new sets of components that have a high overlap of usage characteristics are identified and a higher rank is assigned to those new sets of components. For example, a new component set containing a fiberoptic transmitter and an infrared receiver is lower ranked compared to a component set containing an infrared transmitter and infrared receiver, because there are existing combinations of infrared transmitters and infrared receivers within individual information sources 206 and there is a very low probability of a single information source containing a “fiber optic transmitter” in close textual proximity to an “infrared receiver”.

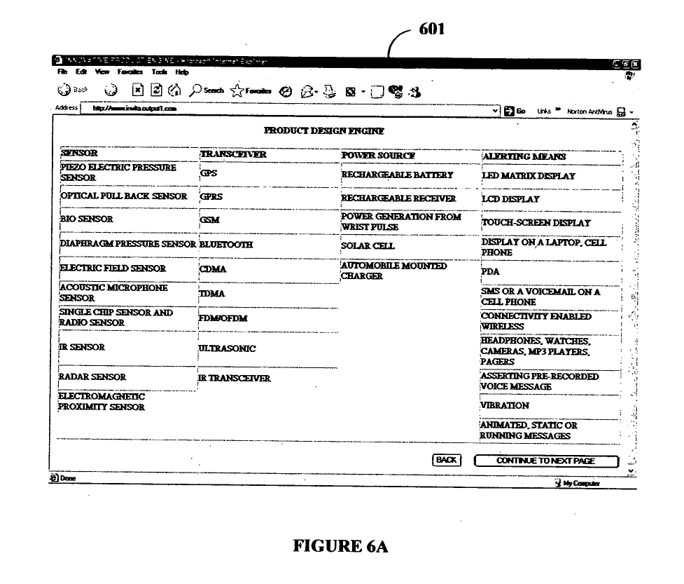

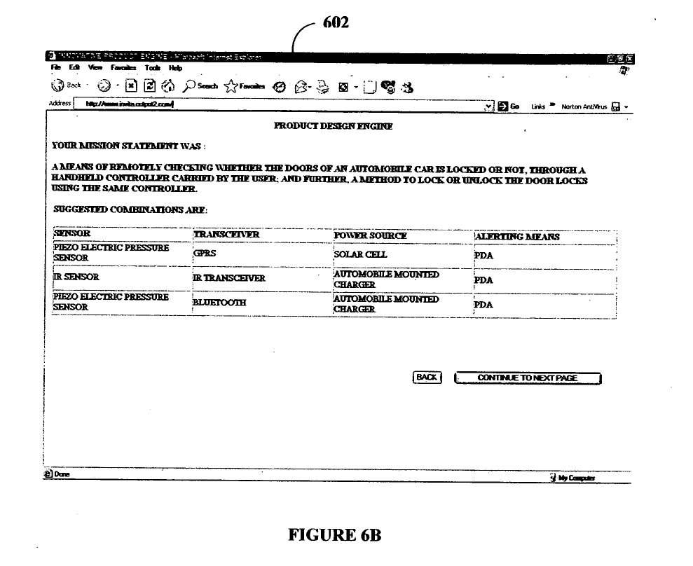

FIG. 6A displays the results of all the components extracted for the known functions of the automotive lock and alarm system 601. If there are n components identified for known function A, m functions identified for known function B and 1 functions identified for known function C, a total of 1×m×n new sets of component combinations can be potentially derived. In the given example of the automotive lock and alarm system, there are 10 component alternatives for the sensors in the automobile, and 9 component alternatives for the transceiver. There are 5 component alternatives for a power source, and 11 component alternatives for an alerting means. Hence, the total number of new component sets that may potentially perform the known function of the products is 10×9×5×11=4950 possible combinations. Next, the challenge is to select the viable and most effective combination of components among the 4950 possible combinations. The ranking modules provide a solution to this challenge. The synergy check module 215 and novelty check module 216 here successively ranks on the factors of synergy and novelty.

The novelty check module ranks new sets of components based on novelty of the combination of new components. The use of the novelty check module 216 is optional. The novelty check module 216 applies a novelty check logic to determine the level of novelty. The novelty check logic comprises breaking down the elements of a claim into a component and its application. The author of this patent application, in a previously submitted U.S. patent application titled “Component and Application Finder”, application Ser. No. 10/957,906 filed on 04 Oct. 2004, describes this method of braking down the elements of a claim. If some or all of these new components in a component set reside in any single claim of a patent document, a higher ranking is awarded those sets of new components wherein the least number of components within each new set occur in a single claim of a patent document. A check is then made to determine whether all or any of these components reside in a single claim of any patent document. As this combination does not have any two component used in any other patent, this combination is termed the most unique and this set is given the highest rank.

Finally, the new product generation engine 200 outputs the highest ranked component sets to the product designer. FIG. 6B illustrates the outputs of the new product generation engine 200 for the automotive locking and alarm system example 602. One suggested solutions for an automotive car lock and alarm system includes using a combination of piezoelectric pressure sensor, general packet radio service (GPRS) and solar cell. Another suggested solution includes an IR sensor, IR transceiver, automobile mounted charger and PDA. Another suggested solution includes piezoelectric pressure sensor, bluetooth, automobile mounted charger and PDA. Many such new combinations are suggested and are ranked highest amongst the 4950 possible combinations. Only three combinations are exemplified in FIG. 6B.

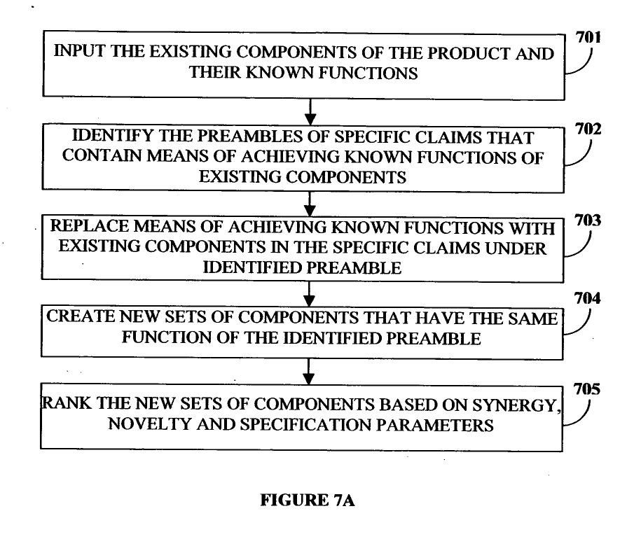

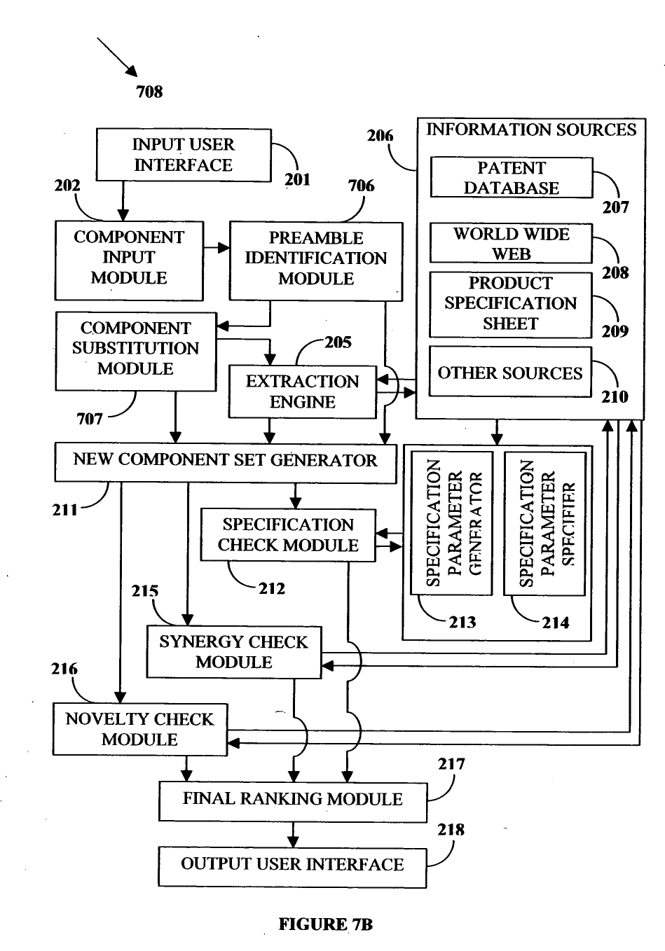

FIG. 7A illustrates the method of identifying a new application and designing a new product to accomplish the new application. The existing components of the known product and their known functions are entered 701. The claims section of patent documents is searched and the preambles of those specific claims that contain means of achieving the existing functions in the body of the specific claims is identified 702. For example, the claim is an apparatus or method type claim containing multiple means with their respective functions. Next, the means of achieving known functions in the specific claims is replaced with the existing components that are listed under each said identified preamble, thereby creating a new product that contains a new set of components that has the same function as the function of the identified preamble 703, 704. Finally, the new sets of components are ranked 705.

FIG. 7B illustrates the architecture of the function innovation engine 708 that implements each step of the method of FIG. 7A. This method and system allows product designers to design new products in non-traditional markets using their existing components. First, the existing components and their known functions that form the existing product are inputted through an input user interface 201. In the claims section of a patent document, a claim typically comprises multiple elements, i.e., multiple means listed with their respective functions. The claim section of all the patent documents in the patent database is searched 207 using a preamble identification module 706. The claims that contain two or more known functions of the components of the product being designed by the product designer are selected. In these selected claims, the preambles of independent claims typically states the means of achieving the overall mission, i.e., it states the main product. Two or more components within this main product can now be replaced with the existing components. The component substitution module 707 accomplishes this replacement process textually. Therefore, a new product is created that contains a new set of component means that solves the function of the preamble. Similarly, multiple such new products can be configured using the known components. Next, these new sets of products are ranked using the novelty check module 216, synergy check module 215 and specification check module 212. The details of the method of ranking, the input user interface 201, component input module 202, extraction engine 205, information sources 206, patent database 207, world wide web 208, product specification sheet 209, other sources 210, new component set generator 211, specification check module 212, application parameter generator 213, application parameter specifier 214, synergy check module 215, novelty check module 216, final ranking module 217 and output user interface 218 have been described under the description of FIG. 2.

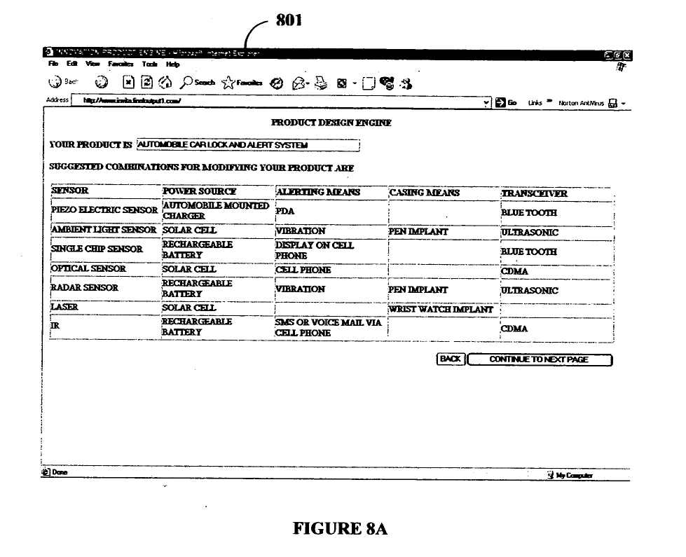

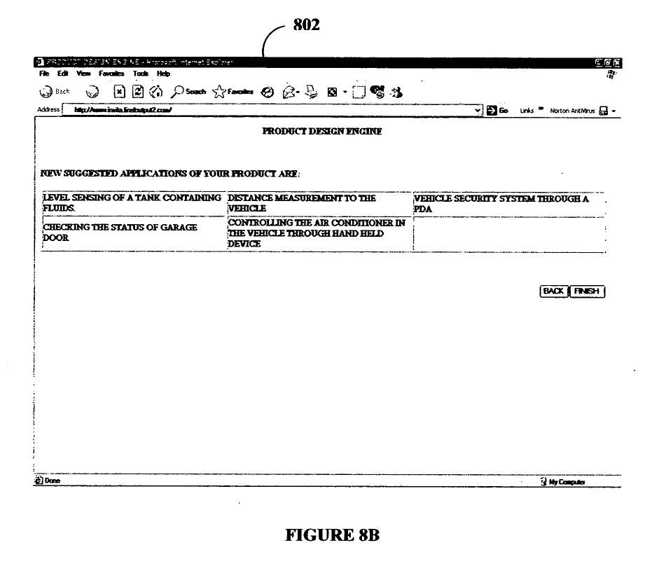

The product designer now wishes to identify new applications for his components in non-traditional markets and design products for new application using some of the existing components present in the current product. The product designer lists the functions of the current components, for example, communicating, lock status sensing, controlling the lock, displaying, alerting, powering, and enclosing. Using the preamble search module, the patent database 207 is searched for patents that contain claims comprising two or more known functions of the existing components of the product being designed by the product designer. The author of this patent application, in a previously submitted United States patent application titled “Component and Application Finder”, application Ser. No. 10/957,906 filed on 04 Oct. 2004, provides the method of searching by component and application within the claims section of a patent document. In the given example, the functions of communication and sensing are chosen as critical functions and a search is conducted in the patent claims for these critical functions using the preamble search identification module 706. The preamble identification module 706 identifies a claim in the patent that contains both the functions, namely, both the communicating and sensing functions. Similarly many such claims are identified in multiple documents and the results are ranked by the synergy check module 215, specification check module 212 and novelty check module 216. The final output of the function innovation engine 708 is displayed in FIG. 8A and FIG. 8B 801, 802.

I claim:

1. A method of designing a new product for a predetermined function with new components using textual analysis of information sources, comprising the steps of:
inputting the existing components of said existing product and listing the known functions of said existing components;
identifying and extracting new components that perform the known functions by searching for the known functions in the text within said information sources;
creating new sets of components using said extracted new components, wherein each new set comprises new components identified to perform each of the known functions, with each new set of components performing the required overall function of the existing product;
generating specification parameters of the existing components and specifying the permissible range of values of each said specification parameter;
ranking the new sets of components, further comprising one or more of the steps of:
ranking the new sets of components based on the synergy between components;
ranking by specification parameters, wherein higher ranks are awarded to those new sets of components which contain components whose parameter values lie within said permissible range of values;
awarding higher ranks to those new sets of components which contain at least one component that is an existing component within the existing product.

2. The method of claim 1, wherein the information source comprises the world wide web, commercial information sources, patents and technical documents.

3. The method of claim 1, wherein the method of extraction of the new components that perform the functions of the existing components, comprises the steps of conducting a search and thereafter extracting the new components from the claims section of patent documents, further comprising the steps of:
segmenting a claim into component sections by executing a component extraction logic function in the claims;
segmenting said component sections into components and their functions, by executing a function extraction logic; and
extracting only those components whose functions are similar to the functions of said respective existing components.

4. The method of claim 1, wherein the step of generating specification parameters of the existing components and specifying the permissible range of values of each said specification parameter, further comprises the steps of:
identifying product specification documents of the existing product in said information sources, by identifying product specification document markers in said information sources, wherein said product specification markers are unique text and the structural arrangement of said unique text in the product specification document; and
extracting the specification parameters and their specification range, thereby setting a target specification for said new product.

5. The method of claim 1, wherein the step of ranking the new sets of components based on the synergy between components, comprises the steps of ranking based on industry vertical synergy, wherein a higher rank is awarded to a new set of components if more than one of the components of the new set of components have applications in a common industry vertical.

6. The method of claim 1, wherein the step of ranking new sets of components based on the synergy between components, comprises the steps of ranking based on textual proximity, wherein a higher rank is awarded to a new set of components if more than one of the components of the new set of components lie. in close textual proximity in a specific information source.

7. The method of claim 1, wherein the step of ranking new sets of components based on the synergy between components, comprises the steps of ranking based on sub-component overlap synergy, wherein a higher rank is awarded to a new set of components if two or more of the components of the new set of components have a common sub-component.

8. The method of claim 1, wherein the step of ranking further comprises the step of ranking based on novelty of the combination of the new components, further comprising the step of determining if some or all of these components reside in any single claim of a patent document, wherein a higher ranking is awarded to those new sets of components that contain the least number of components that occur within a claim of a patent or prior art document.

9. A method of identifying a new application and designing a new product to accomplish said new application, from an input for an existing product that performs an existing function with its existing components, by replacing, removing or integrating one or more of said existing components with new components, comprising the steps of:
inputting the existing components that form said existing product and listing their known functions;
searching the claims section of patent documents and identifying the preambles of those specific claims that contain means of achieving said existing functions in the body of said specific claims, wherein the claim is an apparatus or method type claim containing multiple means with their respective functions;
replacing said means of achieving known functions in the specific claims with the existing components that are listed under each said identified preamble, thereby creating a new product that contains a new set of components that has the same function as the function of the identified preamble; and
ranking said new sets of components.

10. The method of claim 9, where the step of ranking new sets of components further comprises the steps of:
generating specification parameters of said existing components and specifying their permissible range of values; and
ranking by specification parameters, wherein higher ranks are awarded to those sets of components which contain components whose parameter values lie within said permissible range of values.

11. The method of claim 9, wherein the step of ranking new sets of components, comprises the steps of ranking based on industry vertical synergy, wherein a higher rank is awarded to a new set of components if more than one of the components of the new set of components have applications in a common industry vertical.

12. The method of claim 9, wherein the step of ranking new sets of components, comprises the steps of ranking based on textual proximity synergy, wherein a higher rank is awarded to a new set of components if more than one of the components of the new set of components lie in close textual proximity within a specific information source.

13. The method of claim 9, wherein the step of ranking new sets of components, comprises the steps of ranking based on subcomponent overlap synergy, wherein a higher rank is awarded to a new set of components if more than one of the subcomponents of the components of the new set of components are the same.

14. The method of claim 9, wherein the step of ranking further comprises the step of ranking based on novelty of the combination of the new components, further comprises the step of determining if some or all of these components reside in any single claim of a patent document, wherein higher ranking is awarded to those new sets of components which contain the least number of components that occur within a claim of a patent or prior art document.

15. The method of claim 9, wherein the step of ranking said new sets of components comprises awarding higher ranks to those new sets of components that contain at least one component that is an existing component within the existing product.

16. The method of claim 9, the step of searching the claims section of patents and identifying those preambles of specific claims that contain means of achieving said known functions in the body of said specific claims, comprises the steps of:
identifying new components that perform said known functions by searching for words or synonyms of said words that illustrate the function of the existing components in the text of said claims; and
extracting those preambles of claims that contain means of achieving the known functions in the body of the claims.

17. The method of claim 9, wherein the method of identifying the preambles of those specific claims that contain means of achieving said known functions, further comprises the steps of:
segmenting a claim into component sections by executing a component extraction logic function in the claims;
segmenting said component sections into components and their functions, by executing an application extraction logic function; and
identifying the preambles of those specific claims that contain means whose respective functions are similar to the functions of said existing components.
